(19) United States
(12) Patent Application Publication
(10) Pub. No.: US 2005/0073926 A1
(43) Pub. Date: Apr. 7, 2005

(54) Method of detecting an optical disk and the optical disk drive thereof

(76) Inventor: Kuo-Chun Lee, Gueishan Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/945,341

(22) Filed: Sep. 20, 2004

(30) Foreign Application Priority Data
Oct. 2, 2003 (TW) 92127359

(51) Int. Cl. G11B 5/58; G11B 7/00

(52) U.S. Cl. 369/53.2

(57) ABSTRACT

A method of detecting an optical disks applied in an optical disk drive is disclosed. The optical disk drive includes a spindle motor and an optical pickup unit (OPU). The method includes steps of moving the optical pickup unit to a first position; controlling the optical pickup unit to emit a first laser beam; detecting if any to-be-read disk is loaded in the optical disk drive according to the reflection of the first laser beam, and ending the method if no to-be-read disk is loaded in the optical disk drive; moving the optical pickup unit to a second position; controlling the optical pickup unit to emit a second laser beam; and determining the scale of the to-be-read disk according to the reflection of the second laser beam.

This application claims the benefit of Taiwan application Serial No. 92127359, filed Oct. 2, 2003, the subject matter of which is incorporated herein by reference.

### BACKGROUND OF THE INVENTION

1. Field of the Invention

The invention relates in general to a method of detecting an optical disk and the optical disk drive thereof, and more particularly to a method of detecting an optical disk and the optical disk drive thereof, which detects the presence of an optical disk and the scale of the optical disk according to the reflection of a laser beam emitted by an optical pickup unit.

2. Description of the Related Art

Along with the thriving development in Internet and multimedia industries, optical disks have displaced the cassette tapes because the former store a larger volume of data and preserve the stored data for a longer duration in a better condition than the latter. Optical disks such as CD-ROM, DVD-ROM and CD-RW have thus become mainstream media in terms of data storage.

Ordinary optical disks have two scales of diameter, namely, 12 cm optical discs and 8 cm optical discs. The 12 cm optical disk having the conventional scale is for storing ordinary image, voice and MP3 data; the 8 cm optical disk is a late model and is mainly for storing MP3 data. In terms of configuration, an optical disk drive is a device for accessing the data stored in an optical disk. For example, the optical disk drive of a personal computer or a notebook may read the data stored in an optical disk; a VCD or DVD player, may play programs stored in the optical disk; a CD-Writer may write data in an optical disk or read the data stored in the optical disk.

Referring to FIG. 1, a schematic structural diagram of a conventional optical disk drive. The optical disk drive 100 has a tray 110, a spindle motor 130, an optical pickup unit 140 and a circuit board 150. The tray 110 is for carrying an optical disk 120, say, a 12 cm optical disk 120a or an 8 cm optical disk 120b, which may be loaded into or unloaded from the optical disk drive 100 along the arrow direction shown in the diagram. The spindle motor 130 is for fixing and rotating the optical disk 120 loaded into the tray 110. The optical pickup unit 140 is for accessing the data stored in the optical disk 120, converting the accessed data into electric signals and transmitting the converted signals to the circuit board 150.

After having been actuated, the optical disk drive 100 will detect first whether the tray 110 has been loaded with the optical disk 120 or not before starting to read the optical disk 120, lest the optical pickup unit 140 should read erroneous signals and cause errors when actually no optical disk is loaded. After having detected the presence of the optical disk 120, the optical disk drive 100 will further identify whether the optical disk 120 loaded is a 12 cm optical disk 120a or a 8 cm optical disk 120b so as to decide the range of movement of the optical pickup unit 140 and set up corresponding parameters. The conventional method of detecting the optical disk is disclosed below. Send a controlling signal from the circuit board 150 to drive the spindle motor 130 to rotate. Due to the inertia difference of the optical disk 120 itself, the larger scale the optical disk has, the heavier it weighs, and consequently, the slower it rotates as driven by the spindle motor 130.

Apply a constant torque to the spindle motor 130 and detect the speed of rotation of the spindle motor 130 within a pre-set duration of time or detect the required time for the spindle motor 130 to reach a pre-set speed of rotation. If the speed of rotation is over a first speed, this implies that the optical disk drive 100 carries no optical disk 120. If the speed of rotation is below a second speed, which is slower than the first speed, this implies that the optical disk drive 100 carries a 12 cm optical disk 120a. If the speed of rotation ranges between the first speed and the second speed, this implies that the optical disk drive 100 carries an 8 cm optical disk 120b. Alternatively, if the time of rotation is over a first duration of time, this implies that the optical disk drive 100 carries a 12 cm optical disk 120a. If the duration of rotation is below a second duration of time, which is shorter than the first duration of time, this implies that the optical disk drive 100 carries no optical disk 120. If the duration of rotation ranges between the first duration of time and the second duration of time, this implies that the optical disk drive 100 carries an 8 cm optical disk 120b.

However, the conventional method of detecting whether the optical disk 120 is loaded or not and whether the loaded optical disk is a 12 cm optical disk 120a or a 8 cm optical disk 120b has the following disadvantages:

1. In order to correctly measure the scale of the optical disk, the mechanic method of using the rotation of the spindle motor to detect the optical disk requires a constant amount of time for rotating the spindle motor. Therefore, the optical disk detecting time can hardly be further reduced.

2. The spindle motor must clamp the optical disk firmly so that the presence and the scale of the optical disk may be precisely detected according to the duration of rotation or the speed of rotation of the spindle motor. If the spindle motor fails to clamp the optical disk firmly due to manufacturing variations, incorrect detections would arise. That is, the optical disk drive might be detected to carry no optical disk when actually the optical disk drive is loaded with one; a 12 cm optical disk loaded might be detected to be a 8 cm optical disk; or a 8 cm optical disk loaded, which is thicker than the normal scale, and thus turns slower, might be detected to be a 12 cm optical disk. All these will lead to a poor reliability of detection.

### SUMMARY OF THE INVENTION

It is therefore an object of the invention to provide a method of detecting an optical disk and the optical disk drive thereof, which detects the presence of optical disk and further identifies whether the optical disk loaded is a 12 cm optical disk or a 8 cm optical disk according to the reflection of a laser beam emitted by an optical pickup unit,. The invention requires a shorter detecting duration and produces more reliable results. When combined with the conventional method, the invention may further determine if the optical disk is fixed on the spindle motor.

The invention achieves the above-identified object by providing an optical disk drive including an optical disk carrying portion, a spindle motor, an optical pickup unit and a determination device. The optical disk carrying portion is for carrying the to-be-read optical disk, which may be a first scale optical disk or a second scale optical disk with the second scale optical disk being larger than the first scale optical disk. The spindle motor is disposed on the optical disk carrying portion for rotating the to-be-read optical disk. The optical pickup unit is for accessing the data stored in the optical disk. The determination device is electrically coupled to the optical pickup unit for determining whether the optical disk carrying portion carries a to-be-read optical disk or not and determining the scale of the to-be-read optical disk. The optical pickup unit emits a first laser beam from a first position and whether the optical disk carrying portion carries a to-be-read optical disk is determined according to reflection of the first laser beam: if the optical disk carrying portion is detected to carry a to-be-read optical disk, the optical pickup unit continues to emit a second laser beam from a second position and the scale of the to-be-read optical disk is determined according to the reflection of the second laser beam. The distance between the first position and the spindle motor is less than the radius of the first scale optical disk, while the distance between the second position and the spindle motor ranges between the radii of the first scale optical disk and the second scale optical disk. Detecting the status of the optical disk according to the laser beam can produce more reliable results in a shorter duration.

The invention achieves the above-identified object by providing a method of detecting an optical disk applied in an optical disk drive. The to-be-read optical disk may be a first scale optical disk or a second scale optical disk with the second scale optical disk being larger than the first scale optical disk. The optical disk drive includes an optical pickup unit and a spindle motor. The method includes the steps of moving the optical pickup unit to a first position; emitting a first laser beam by the optical pickup unit; determining whether the optical disk drive carries an optical disk or not according to the reflection of the first laser beam, in which this method ends if no to-be-read optical disk is loaded; moving the optical pickup unit to a second position; emitting a second laser beam by the optical pickup unit; and determining the scale of the to-be-read optical disk according to the reflection of the second laser beam.

The distance between the first position and the spindle motor is less than the radius of the first scale optical disk, while the distance between the second position and the spindle motor ranges from the radius of the first scale optical disk to that of the second scale optical disk. The determination device will determine that the optical disk carrying portion is loaded with a to-be-read optical disk if the reflection of the first laser beam received by the optical pickup unit is over a pre-determined value. The determination device will determine that the to-be-read optical disk loaded in the optical disk carrying portion is a first scale optical disk if the reflection of the first laser beam received by the optical pickup unit is below the pre-determined value. The determination device will determine that the to-be-read optical disk loaded in the optical disk carrying portion is a second scale optical disk if the reflection of the second laser beam received by the optical pickup unit is over the pre-determined value. The first scale optical disk is an 8 cm optical disk while the second scale optical disk is a 12 cm optical disk. Detecting the status of the optical disk according to the laser beam can produce more reliable results in a shorter duration.

The invention achieves the above-identified object by providing a method of detecting an optical disk applied in an optical disk drive. The to-be-read optical disk may be a first scale optical disk or a second scale optical disk with the second scale optical disk being larger than the first scale optical disk. The optical disk drive includes an optical pickup unit for accessing the data stored in the optical disk and a spindle motor for fixing and rotating the optical disk. The method includes the steps of moving the optical pickup unit to a first position; emitting a first laser beam by the optical pickup unit; determining whether the optical disk drive carries an optical disk or not according to the reflection of the first laser beam, in which this method ends if no to-be-read optical disk is loaded; moving the optical pickup unit to a second position; emitting a second laser beam by the optical pickup unit; determining the scale of the to-be-read optical disk according to the reflection of the second laser beam; activating the spindle motor to rotate for a constant duration of time; determining whether a to-be-read optical disk is fixed on the spindle motor or not according to the speed of rotation of the spindle motor after having rotated for the constant duration of time. Also, the spindle motor can be actuated to rotate at a constant speed, and whether a to-be-read optical disk is fixed on the spindle motor can be determined according to the time required for the spindle motor to reach the constant speed of rotation.

If the to-be-read optical disk is identified as the first scale optical disk and the speed of rotation is higher than the first speed, the to-be-read optical disk is determined not to be fixed on the spindle motor. If the to-be-read optical disk is identified as the second scale optical disk and the speed of rotation is higher than the second speed, the to-be-read optical disk is determined not to be fixed on the spindle motor. Of which, the second speed is lower than the first speed. Combined with the conventional method of detecting an optical disk, the invention not only detects the presence and the scale of an optical disk, but also confirms if the to-be-read optical disk is fixed on the spindle motor.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic structural diagram of a conventional optical disk drive;

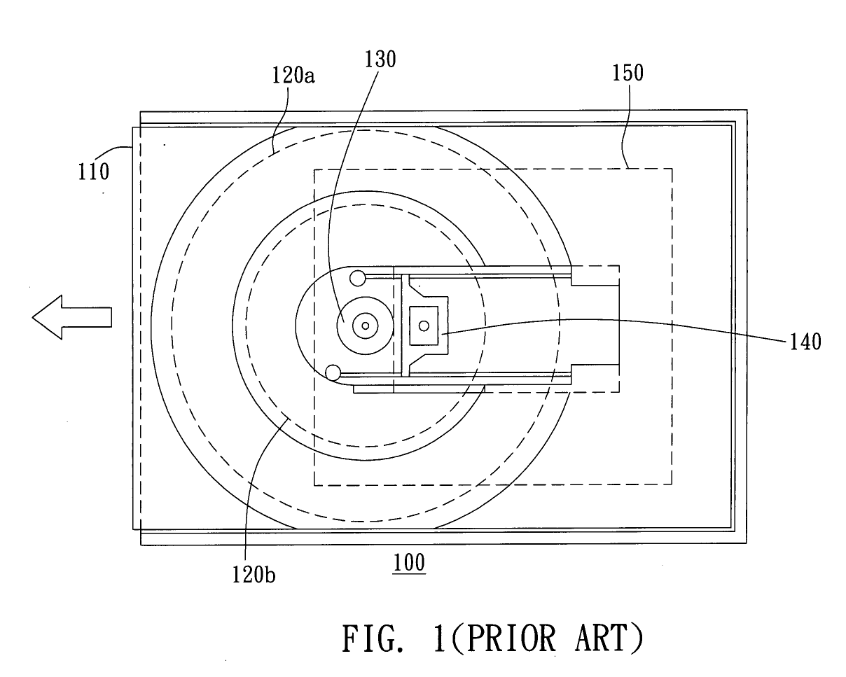

FIG. 2A is a structural top view of an optical disk drive according to a preferred embodiment of the invention;

FIG. 2B is a structural side view of the optical disk detection by using the optical pickup unit in FIG. 2A; and

FIG. 3 is a flowchart of the method of detecting an optical disk according to a preferred embodiment of the invention.

### DETAILED DESCRIPTION OF THE INVENTION

The characteristic of the invention lies in whether an optical disk drive is loaded with an optical disk or not and whether the loaded optical disk is a 8 cm optical disk or a 12 cm optical disk can be determined promptly and precisely according to the reflection of a laser beam emitted by an optical pickup unit of an optical disk drive. Therefore, the efficiency and precision of the optical disk drive in detecting an optical disk can be improved.

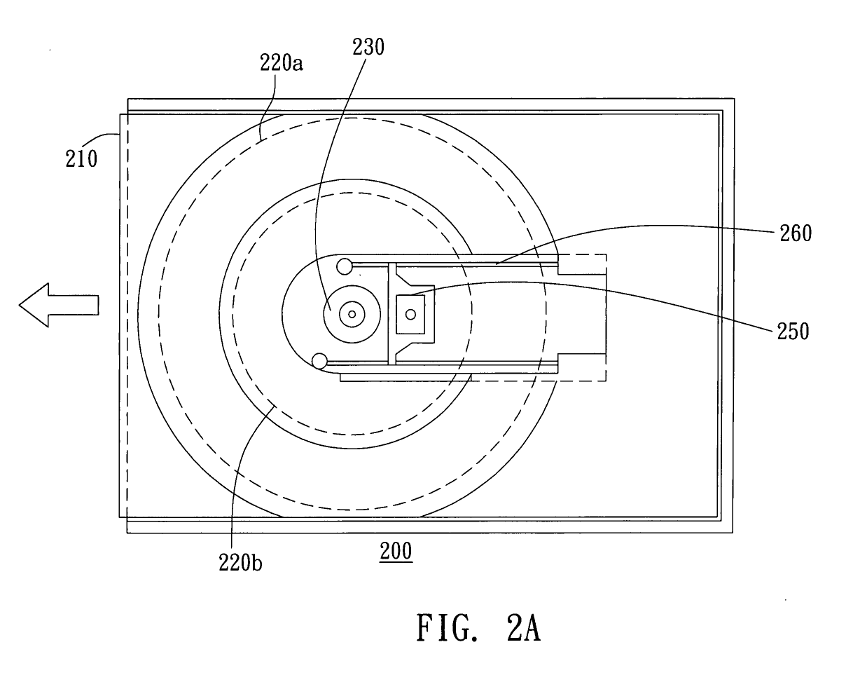

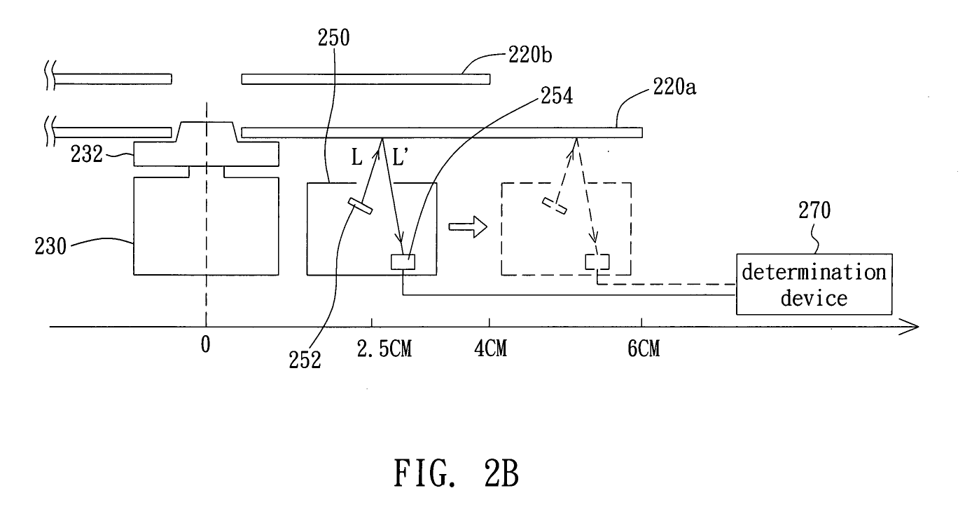

Referring to FIG. 2A and FIG. 2B at the same time, a structural top view of an optical disk drive according to a preferred embodiment of the invention, and a structural side view of the optical disk detection by using the optical pickup unit in FIG. 2A are respectively shown. The optical disk drive 200 mainly includes a tray 210, a spindle motor 230, an optical pickup unit 250 and a determination device 270. The tray 210 is used for carrying a to-be-read optical disk 220, a 12 cm optical disk 220a or an 8 cm optical disk 220b for instance. The spindle motor 230, which drives the to-be-read optical disk 220 to rotate, further includes a damper 232 for fixing the to-be-read optical disk 220. The optical pickup unit 250, which slides along a rail 260 to access the data stored in the to-be-read optical disk 220, further includes a luminous module 252 and a receiving module 254, such as a photo diode. The determination device 270 is electrically coupled to the receiving module 252 of the optical pickup unit 250 and detects the presence and the scale of the to-be-read optical disk 220 according to reflection of a laser beam. When the optical disk drive 200 is actuated, the focusing and tracking of the optical pickup unit 250 is usually operated first in order to calibrate the focus of the laser source of the optical pickup unit 250 and lock the optical pickup unit 250 at the home position on the rail 260. Normally the home position is located nearest the spindle motor 230. Next, the presence and the scale of the to-be-read optical disk 220 are detected.

As shown in FIG. 2B, the characteristic of the invention lies in the presence and the scale of the to-be-read optical disk 220 is detected according to the reflection of the laser beam L emitted by the optical pickup unit. The optical pickup unit 250 emits a laser beam at the home position, 2.5 cm away from the spindle motor 230 for instance. The luminous module 252 emits the laser beam L towards the to-be-read optical disk 220, while the receiving module 254 receives the reflection light L′ of the laser beam. The determination device 270 detects the presence of the to-be-read optical disk according to the reflection of the laser beam. If the received reflection amount of the laser beam is over a pre-determined value, which implies existence of reflection, the determination device 270 will determine that the optical disk drive 200 is loaded with a to-be-read optical disk 220, otherwise the presence of the to-be-read optical disk is denied.

After confirming the presence of the to-be-read optical disk 220, the optical pickup unit 250 slides along the rail 260 to a position 4 to 6 cm away from the center of the spindle motor 230, and then the optical pickup unit 250 emits a laser beam again as shown in FIG. 2B. Similarly, if the received reflection amount of the laser beam is over a pre-determined value, which implies existence of reflection, the determination device 270 will identify the to-be-read optical disk 220 as a 12 cm optical disk; if the received reflection amount of the laser beam is below the pre-determined value, which implies the absence of reflection, the determination device 270 will identify the to-be-read optical disk 220 as a 8 cm optical disk. Since the laser beam emitted from the luminous module 254 at the second position can only be reflected by a 12 cm optical disk 220a but not a 8 cm optical disk due to the inadequate radius of the 8 cm optical disk, whether the to-be-read optical disk 220 loaded on the optical disk drive 200 is a 12 cm optical disk 220a or a 8 cm optical disk can thus be identified.

Although the invention disclosed above uses an optical disk drive 200 with a tray 210 as an example, the invention is not limited thereto. Any optical disk drive whose optical disk carrying portion is able to carry an optical disk 220, a top-loading optical disk drive or a disk-drawing optical disk drive for instance, is within the scope of skill of the invention.

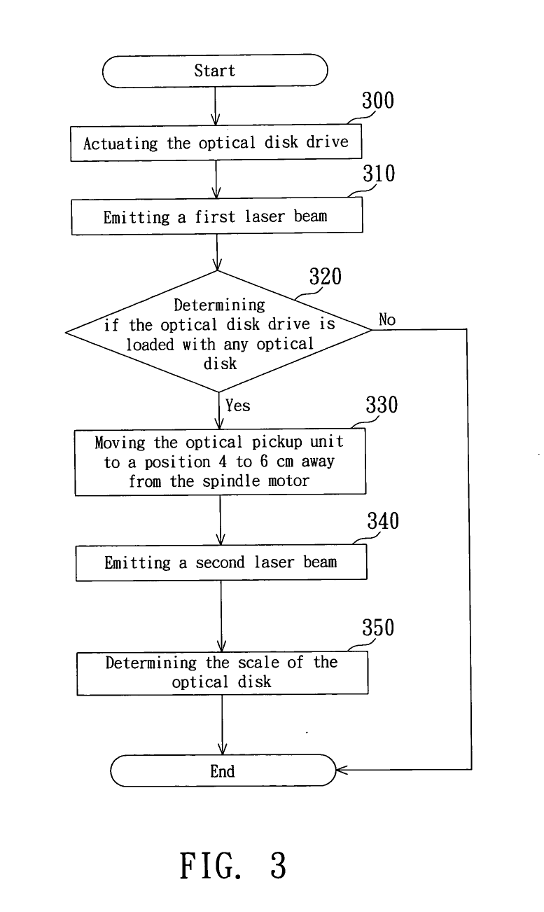

Referring to FIG. 3, a flowchart of the method of detecting an optical disk according to a preferred embodiment of the invention is shown. Firstly, in the step 300, actuate the optical disk drive 200, in which the optical pickup unit 250 is tracked and locked at the home position. Next, proceed to step 310 of emitting a first laser beam by using the optical pickup unit 250 and receiving the reflection of the first laser beam by using the receiving module 254. Proceed to step 320 of determining the presence of the to-be-read optical disk by using the determination device 270 according to the reflection of the first laser beam received by the receiving module 254. If the received reflection amount of the first laser beam is below a pre-determined value, which means no reflection, the determination device 270 will determine that the optical disk drive 200 is not loaded with any to-be-read optical disk, and the method ends here; otherwise, if the received reflection amount of the first laser beam is over the pre-determined value, which implies existence of reflection, the determination device 270 will determine that the optical disk drive 200 is loaded with an to-be-read optical disk 220, and the approach proceeds to step 330.

In the step 330, move the optical pickup unit 250 to a position 4 to 6 cm away from the center of the spindle motor 230 promptly. Normally the motor of the optical pickup unit 250 rotates and brings the optical pickup unit 250 to slide along the rail 260. The moving distance of the optical pickup unit 250 is controlled by the speed and duration of the rotation of the motor. Following that, proceed to step 340 to emit a second laser beam by the optical pickup unit 230 and receive the reflection of the second laser beam by the receiving module 254. Proceed to step 350 to determine the scale of the to-be-read optical disk 220 according to the reflection of the second laser beam by using the determination device 270. The determination device 270 will identify the to-be-read optical disk 220 as a 8 cm optical disk 220b if the reflection amount of the second laser beam is below a pre-determined value and identify the to-be-read optical disk 220 as a 12 cm optical disk 220a if the reflection amount of the second laser beam is over the pre-determined value, and this method ends here.

In the method of detecting an optical disk according to the invention, a first laser beam is emitted first at the home position, which can be less than 4 cm away from the center of the spindle motor 230, and where the emitted first laser beam can be reflected by the to-be-read optical disk 220 fixed on the spindle motor 230. Next, the second laser beam is emitted as the optical pickup unit 250 is moved to a distance 4 to 6 cm away from the center of the spindle motor 230 to identify whether the loaded to-be-read optical disk 220 is a 12 cm optical disk 220a or a 8 cm optical disk 220b. With regard to the 9 cm rectangular disk whose fringe records no data, it can be classified as an 8 cm optical disk. When the optical pickup unit 250 is moved to be close but not over the 6 cm distance from the center of the spindle motor 230 and emits a laser beam toward the 9 cm optical disk, no laser beam is reflected from the 9 cm optical disk and the optical disk drive 200 will thus determine that the loaded to-be-read optical disk 200 is an 8 cm optical disk 220b.

Moreover, when combined with the conventional method of detection, the method of detecting an optical disk according to the invention can detect whether the to-be-read optical disk 220 is fixed on the spindle motor or not. First, by using the method mentioned above, the presence of the optical disk 220 is determined and the to-be-read optical disk 220 is identified as a 8 cm optical disk 220b or a 12 cm optical disk 220a. Next, use the conventional method of detection to actuate the spindle motor 230 to rotate for a predetermined duration of time, and then measure the speed of rotation. As disclosed above, if the speed of rotation is higher than a first speed, it means no to-be-read optical disk 220 is loaded; if the speed of rotation is below a second speed, it means the loaded to-be-read optical disk 220 is a 12 cm optical disk 220a is concluded; if the speed of rotation ranges from the first speed to the second speed, that the loaded to-be-read optical disk 220 is a 8 cm optical disk 220b is concluded.

If the optical disk drive 200 is loaded with an optical disk 220 but the conventional method of detection detects no optical disk (the speed of rotation of the spindle motor 230 is over the first speed) or if the method of detection according to the invention identifies the to-be-read optical disk 220 as a 12 cm optical disk but is identified as an 8 cm optical disk according to the conventional method of detection (the speed of rotation of the spindle motor 230 is over the second speed), this implies that the spindle motor 230 fails to fix the to-be-read optical disk 220. Under these circumstances, the spindle motor 230 can be adjusted or replaced. Of course, when combining the conventional method with the method of the invention, the user can also choose to actuate the spindle motor 230 to reach a pre-set speed of rotation and measure the required time to determine whether the to-be-read optical disk 220 is fixed on the spindle motor 230 or not.

As disclosed in the above preferred embodiments, the method of detecting an optical disk according to the invention has the following advantages:

1. Detecting whether the optical disk drive carries an optical disk or not according to the existence of the reflection of a first laser beam requires a short duration of time. After having confirmed that the optical disk drive carries an optical disk, the optical pickup unit is moved to emit a second laser beam so that the scale of the optical disk can be detected according to the existence of the reflection of the second laser beam, so the method of detection according to the invention is much faster than the conventional method, which uses the rotation of the spindle motor to detect optical disk.

2. In the invention, the presence of an optical disk is determined according to the existence of the reflection of a first laser beam, and if the presence of an optical disk is confirmed, whether the loaded optical disk is a 12 cm or a 8 cm optical disk is determined according to the existence of the reflection of a second laser beam. By using this simple geometric concept in optical disk detecting, the invention is more straightforward and more reliable than the conventional method, which uses the inertia of the rotation of the spindle motor for the detection of optical disk. Furthermore, the invention avoids erroneous detection that may arise in the conventional method when the optical disk is not fixed firmly on the spindle motor.

3. When combined with the conventional method, the method of the invention not only detects the presence and the scale of the optical disk, but also detects whether the optical disk is firmly fixed on the spindle motor or not, which can facilitate necessary repairs and replacement on the spindle motor.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical disk drive, capable of reading a first scale optical disk or a second scale optical disk, the second scale optical disk being larger than the first scale optical disk, the optical disk drive comprising:
an optical disk carrying portion, for carrying a to-be-read optical disk;
a spindle motor, for rotating the to-be-read optical disk as the to-be-read optical disk is placed in the optical disk carrying portion;
an optical pickup unit, wherein the optical pickup emits a first laser beam towards the optical disk carrying portion from a first position and reads the reflection of the first laser beam accordingly; and
a determination device, electrically coupled to the optical pickup unit and determining whether the optical disk carrying portion carries the to-be-read optical disk or not according to the reflection of the laser beam;
wherein, the distance between the first position of the optical pickup unit and the spindle motor is less than the radius of the first scale optical disk.

2. The optical disk drive according to claim 1, wherein the optical disk carrying portion is a tray.

3. The optical disk drive according to claim 1, wherein the optical pickup unit emits a second laser beam from a second position and identifies the scale of the optical disk according to the reflection of the second laser beam.

4. The optical disk drive according to claim 3, wherein the distance between the second position of the optical pickup unit and the spindle motor ranges from the radius of the first scale optical disk to the radius of the second scale optical disk.

5. The optical disk drive according to claim 1, wherein the determination device determines that the optical disk carrying portion is loaded with the to-be-read optical disk if the reflection amount of the first laser beam received by the optical pickup unit is over a pre-set value.

6. The optical disk drive according to claim 5, wherein the determination device determines that the loaded to-be-read optical disk is the first scale optical disk if the reflection amount of the second laser beam received by the optical pickup unit is below the pre-set value and that the loaded to-be-read optical disk is the second scale optical disk if the reflection amount of the second laser beam received by the optical pickup unit is over the pre-set value.

7. The optical disk drive according to claim 1, wherein the first scale optical disk is an 8 cm optical disk while the second scale optical disk is a 12 cm optical disk.

8. A method of detecting an optical disk, applied in an optical disk drive, the optical disk drive comprising an optical pickup unit and a spindle motor, a to-be-read optical disk being a first scale optical disk or a second scale optical disk, the second scale optical disk being larger than the first scale optical disk, the method comprising the steps of:
(a) moving the optical pickup unit to a first position;
(b) emitting a first laser beam by the optical pickup unit;
(c) determining if the to-be-read disk is loaded in the optical disk drive according to the reflection of the first laser beam, and ending the method if no to-be-read disk is loaded in the optical disk drive;
(d) moving the optical pickup unit to a second position;
(e) emitting a second laser beam by the optical pickup unit; and
(f) determining the scale of the to-be-read disk according to the reflection of the second laser beam.

9. The method according to claim 8, wherein the distance between the first position and the spindle motor is less than the radius of the first scale optical disk.

10. The method according to claim 8, wherein the distance between the second position and the spindle motor ranges from the radius of the first scale optical disk to the radius of the second scale optical disk.

11. The method according to claim 8, wherein the step (c) further comprises the step of determining that no to-be-read optical disk is loaded in the optical disk drive if the reflection amount of the first laser beam is below a pre-set value.

12. The method according to claim 8, wherein the loaded to-be-read optical disk is identified as the first scale optical disk if the reflection amount of the second laser beam is below the pre-set value and is identified as the second scale optical disk if the reflection amount of the second laser beam is over the pre-set value.

13. The method according to claim 8, wherein the first scale optical disk is an 8 cm optical disk while the second scale optical disk is a 12 cm optical disk.

14. A method of detecting an optical disk, applied in an optical disk drive, the optical disk drive comprising an optical pickup unit for accessing the data stored in the to-be-read optical disk and a spindle motor for fixing the to-be-read optical disk and rotating the to-be-read optical disk, the to-be-read optical disk being a first scale optical disk or a second scale optical disk, the second scale optical disk being larger than the first scale optical disk, the method comprising the steps of:
(a) moving the optical pickup unit to a first position;
(b) emitting a first laser beam by the optical pickup unit;
(c) determining if the to-be-read disk is loaded in the optical disk drive according to the reflection of the first laser beam, and ending the method if no to-be-read disk is loaded in the optical disk drive;
(d) moving the optical pickup unit to a second position;
(e) emitting a second laser beam by the optical pickup unit;
(f) determining the scale of the to-be-read disk according to the reflection of the second laser beam; and
(g) determining if the to-be-read optical disk is fixed on the spindle motor according to a rotating state of the spindle motor.

15. The method according to claim 14, wherein the distance between the first position and the spindle motor is less than the radius of the first scale optical disk while the distance between the second position and the spindle motor ranges from the radius of the first scale optical disk to the radius of the second scale optical disk.

16. The method according to claim 14, wherein no to-be-read optical disk is loaded in the optical disk drive is determined if the reflection amount of the first laser beam is below a pre-set value, while the loaded to-be-read optical disk is identified as the first scale optical disk if the reflection amount of the second laser beam is below the pre-set value and is identified as the second scale optical disk if the reflection amount of the second laser beam is over the pre-set value.

17. The method according to claim 14, wherein the step (g) further comprising steps of:
actuating the spindle motor to rotate for a predetermined duration of time; and
determining if the to-be-read optical disk is fixed on the spindle motor according to a speed of rotation after the spindle motor has rotated for the predetermined duration of time.

18. The method according to claim 17, wherein if the to-be-read optical disk is identified as the first scale optical disk and the speed of rotation is higher than a first speed, the to-be-read optical disk is concluded not to be fixed on the spindle motor.

19. The method according to claim 17, wherein if the to-be-read optical disk is identified as the second scale optical disk and the speed of rotation is higher than a second speed of rotation, the to-be-read optical disk is concluded not to be fixed on the spindle motor.

20. The method according to claim 14, wherein the spindle motor comprises a clamper for fixing the optical disk.

21. The method according to claim 14, wherein the step (g) further comprising steps of:
actuating the spindle motor to rotate at a predetermined speed; and
determining if the to-be-read optical disk is fixed on the spindle motor according to the time required for the spindle motor to reach the predetermined speed of rotation.

22. A method of detecting an optical disk, applied in an optical disk drive, the optical disk drive comprising an optical pickup unit, the to-be-read optical disk being a first scale optical disk or a second scale optical disk, the second scale optical disk being larger than the first scale optical disk, the method comprising the steps of:
(a) moving the optical pickup unit to a first position;
(b) emitting a laser beam by the optical pickup unit; and
(c) identifying the scale of the to-be-read optical disk according to the reflection of the laser beam.

23. The method according to claim 22, wherein the optical disk drive comprises a spindle motor whose distance from the first position ranges from the radius of the first scale optical disk to the radius of the second scale optical disk.

24. The method according to claim 22, wherein the to-be-read optical disk is identified as the first scale optical disk if the reflection amount of the laser beam is below a pre-set value and is identified as the second scale optical disk if the reflection amount of the laser beam is over the pre-set value.

25. A method of detecting an optical disk in an optical disk drive, the optical disk drive comprising capable of reading a first scale optical disk or a second scale optical disk, the second scale optical disk larger than the first scale optical disk, the optical disk drive comprising an optical pickup unit, an optical disk carrying portion for carrying the to-be-read optical disk, and a spindle motor for rotating the to-be-read optical disk, the method comprising the steps of:
(a) moving the optical pickup unit to a first position whose distance from the spindle motor is less than the radius of the first scale optical disk;
(b) emitting a first laser beam towards the optical disk carrying portion by the optical pickup unit and reading the reflection of the first laser beam accordingly; and
(c) determining if the to-be-read disk is loaded in the optical disk carrying portion according to the reflection of the first laser beam.

26. The method according to claim 25, wherein no to-be-read optical disk is loaded in the optical disk carrying portion is concluded if the reflection amount of the first laser beam is below a pre-set value.
